(19) United States
(12) Patent Application Publication
(10) Pub. No.: US 2023/0148794 A1
(43) Pub. Date: May 18, 2023

(54) Canister Grilling Bar

(71) Applicant: Richard Mohni, Port Huron, MI (US)

(72) Inventor: Richard Mohni, Port Huron, MI (US)

(21) Appl. No.: 17/527,028

(22) Filed: Nov. 15, 2021

(51) Int. Cl. A47J 37/04; A47J 37/07

(52) U.S. Cl. CPC A47J 37/049; A47J 37/07

(57) ABSTRACT

The disclosure provides users with a corn cooking grill attachment which frees up already existing grill space to enable users to cook their meat and cobs of corn simultaneously. The disclosure introduces a novel canister holding bar that can be conveniently placed on the back of the grilling surface or in a campfire. After securing the attachment, the user simply places the canister that holds the corn into the designated holes found on the holding bar. Steam generated from the grill and canister cooks the corn evenly and indicates cooking status. A cap is provided for the canister open end and a push rod is mounted on the nipple end of the canister. A cob screw mounted on an underside of the cap. A collar is configured to receive a plurality of cob screws for cooking the enclosed item(s) adjacent a cooking source.

### BACKGROUND

A barbecue grill or barbeque grill (known as a barbecue or barbie in Australia) is a device that cooks food by applying heat from below. There are several varieties of grills, with most falling into one of three categories: gas-fueled, charcoal, or electric. There is debate over which method yields superior results. Smoking meats, vegetables and other foods has become more popular with hybrid electric and gas models giving more versatility and convenience to cooking outdoors.

Corn on the cob is a culinary term used for a cooked ear of freshly picked maize from a cultivar of sweet corn. Sweet corn is the most common variety of maize eaten directly off the cob. The ear is picked while the endosperm is in the “milk stage” so that the kernels are still tender. Ears of corn are steamed or boiled, usually without their green husks, or roasted with them. The husk leaves are in any case removed before serving. Grilled corn on the cob is popular for enthusiasts and is often grilled in the husk.

### SUMMARY OF THE INVENTION

The main purpose of the Corn Grilling Barbeque Attachment is to provide users with a corn cooking grill attachment. Grilled corn is a side dish often enjoyed alongside a barbeque. Grilling corn, however, can be tedious at times because individuals do not have space on their grills to cook both meat and corn at the same time. Moreover, grilling corn also requires individuals to constantly rotate the cob of corn near a campfire to ensure it does not get burnt and inedible. The Corn Grilling Barbeque Attachment not only cooks the corn to perfection, but also frees up already existing grill space to enable users to cook their meat and cobs of corn simultaneously. Expanding on the initial design of an average barbecue gas or coal grill, the Corn Grilling Barbeque Attachment introduces a novel canister holding bar that can be conveniently placed on the back of the grilling surface and over a campfire. After securing the attachment through the wing nut and attached washer bolt, the user simply places the canister that holds the corn into the designated holes found on the holding bar. As a result, the steam generated from the grill and canister will cook the corn evenly. Therefore, the user will not need to rotate the corn. The Corn Grilling Barbeque Attachment ensures a fully operational corn canister grilling device allows for a more pleasurable and safe grilling experience.

A cooking system disclosed includes a canister configured to enclose an item to be cooked. The canister includes a nipple end and an open end. A cap is provided for the canister open end and a push rod is mounted on the nipple end of the canister. A cob screw mounted on an underside of the cap. A collar is configured to receive a plurality of cob screws for cooking the enclosed item(s) adjacent a cooking source.

### BRIEF DESCRIPTION OF THE DRAWINGS

FIG. 1 is a top perspective view of the Corn Grilling Barbeque Attachment in accordance with an embodiment of the present disclosure.

FIG. 2 is a detail view of the Corn Grilling Canister in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The disclosure includes a stainless steel cylinder or canister, a stainless steel cork style screw attached to a cap or screw lid for the canister and a stainless steel push stake mounted at a cooking end of the canister.

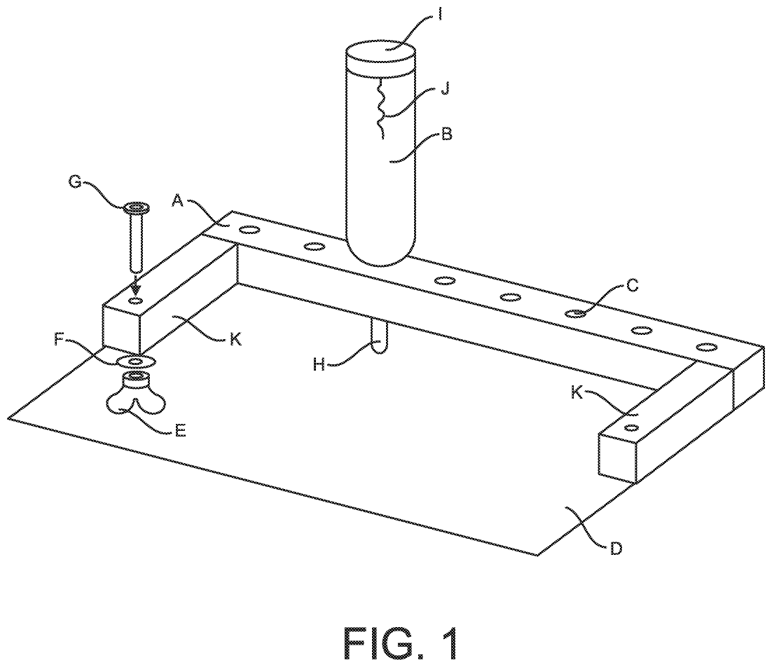

FIG. 1 is a top perspective view of the Corn Grilling Barbeque Attachment in accordance with an embodiment of the present disclosure. The view includes a canister holding bar A, a canister B, holes C defined in the holding bar A, a grilling surface D, a fastener E with a washer F and bolt G, a push stake H mounted to an end of the canister B, a cap I for the canister B, a cork style screw or auger J attached to an underside of the cap I, arms K,

The disclosure includes nominal dimensions for the stainless steel cylinder or canister of length nine inches and outside diameter two and ¾ inches and wall thickness of 0.024 inches, a stainless steel cork style screw of length two inches and size number 2, attached to a cap or screw lid of height 1 and ¼ inches and 4 mm thick, for the canister and a stainless steel push stake of length three inches and 7 mm diameter mounted at a cooking end of the canister also known as a shuttle. A water fill line Q of two inches from the stake H end of the canister is stamped into the metal wall of the canister B.

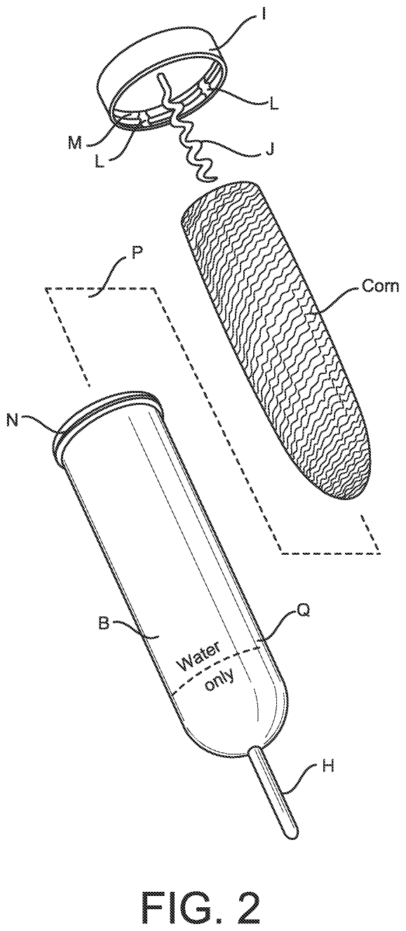

FIG. 2 is a detail view of the Corn Grilling Canister in accordance with an embodiment of the present disclosure. The present view includes limitations of FIG. 1 with same reference letters implied and also depicts steam vents L, helical threads M, complementary threads N, insertion line P and a water and beverage fill line Q. Steam vents L allow water steam to escape the canister B and indicate cooking is in progress and vents pressure to avoid hazardous explosions.

Shuck a cob and break off the husk and screw in the cob screw into a thick side of the cob and down the center of the cob. Put water in the canister up to the two inch fill line. Soda, beer and wine are also used to fill the canister but oil and butter are discouraged. Screw the cap with the cob screw onto the canister top. The canister can be put directly into a campfire and also into a defined hole in the bar on a barbecue. At a campfire, the cannister is pushed into coals, burning wood and embers via the spiked end, also known as a shuttle. The shuttle is left in the campfire in embodiments where only the cap is removed and the cooked corn is taken from the canister still in the campfire. Used shuttles are removed from the campfire died down and can be washed in a dish washer.

Embodiments of the disclosure include different types of metal for the cylinder or canister and cap. A wide platform base instead of a push stake is used in more controlled environments where safety isn't a primary factor including laying the canister down in a fire or barbeque. Therefore, vent holes in the top of the cap or in sides of the canister can also allow venting of the steam during cooking. Tapered canisters following the tapered shape of an ear of corn also are more efficient at cooking than cylindrical canisters and are included in embodiments of the disclosure.

The cap is comprised of aluminum for quick cooling when unscrewed and unfastened from the canister. The cooked corn comes out with the cap and is ready for eating and further disposal mounted to the cob screw or auger. Longer push stakes are available for ground mounting near a cooking or heat source and shorter push rods are used in barbeque environments. The disclosure is safe to use and avoids scalding burns from boiling water or steam due to the cap design and the upright cooking posture of the canister and vent holes therein and in the cap.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A cooking device comprising:
a canister configured to hold an item to be cooked and comprising a nipple end and an open end;
a cap for the canister open end;
a push rod mounted on the nipple end of the canister; and
a cob screw mounted on an underside of the cap.

2. The cooking device of claim 1, wherein the canister is tapered to match a taper of an ear of corn.

3. The cooking device of claim 1, wherein the canister is configured to hold a predetermined amount of water for cooking a contents of the canister.

4. The cooking device of claim 1, wherein the cap and the canister attach together via complementary helical threads on complementary surfaces thereof.

5. The cooking device of claim 1, wherein the cap comprises vent gaps for steam release from within the canister.

6. The cooking device of claim 1, wherein the push rod comprises an auger helical thread for mounting the device in a vertical manner in regards to a water level inside the canister.

7. The cooking device of claim 1, further comprising a collar configured to receive a plurality of cob screws for cooking the held item adjacent a cooking heat source.

8. A cooking system comprising:
a canister configured to enclose an item to be cooked and comprising a nipple end and an open end;
a cap for the canister open end;
a push rod mounted on the nipple end of the canister;
a cob screw mounted on an underside of the cap; and
a collar configured to receive a plurality of cob screws for cooking the enclosed item(s) adjacent a cooking source.

9. The cooking system of claim 8, wherein the canister is tapered to match a taper of an ear of corn.

10. The cooking device of claim 8, wherein the canister is configured to hold a predetermined amount of water for cooking a contents of the canister.

11. The cooking device of claim 8, wherein the cap and the canister attach together via complementary helical threads on complementary surfaces thereof.

12. The cooking device of claim 8, wherein the cap comprises vent gaps for steam release from within the canister.

13. The cooking device of claim 8, wherein the push rod comprises an auger helical thread for mounting the device in a vertical manner in regards to a water level inside the canister.

14. The cooking system of claim 8, further comprising mounting hardware for attaching the collar to a barbecue.

15. The cooking system of claim 8, wherein the collar comprises a bar and two arms configured for mounting to a barbecue grill.
